(19) United States
(12) Patent Application Publication
(10) Pub. No.: US 2004/0054733 A1
(43) Pub. Date: Mar. 18, 2004

(54) E-mail management system and method

(76) Inventor: Richard A. Weeks, Jacksonville, FL (US)

Correspondence Address: Paul E. Franz, Jones, Day, Reavis & Pogue, North Point, 901 Lakeside Avenue, Cleveland, OH, 44114, US

(21) Appl. No.: 10/243,805

(22) Filed: Sep. 13, 2002

(51) Int. Cl. G06F 15/16

(52) U.S. Cl. 709/206

(57) ABSTRACT

A system for selectively stopping the delivery of e-mail messages sent to a user address over a communication network comprises first software executable on a first computer device. The software is stored in a computer readable medium accessible by the first computer device and comprises code operable to define an e-mail stop storage area and store in the e-mail stop storage area e-mail data of e-mail messages selected by the user. The code is further operable to automatically generate stop data based on the e-mail data stored in the e-mail stop storage area to stop the delivery to the user address e-mail messages that correspond to the stored e-mail data.

### BACKGROUND

1. Field of the Invention

The invention relates to systems and methods for processing e-mail, and more particularly to systems and methods for preventing delivery of unwanted or unsolicited e-mail.

2. Description of the Related Art

A user often receives unsolicited e-mail. An unsolicited e-mail is an e-mail that the recipient did not ask or expect to receive, e.g., bulk e-mail, marketing e-mail, e-mail “scams,” etc. Such unsolicited e-mail is often referred to as “spam.”

A user may also receive subscription e-mail. The user may subscribe to receive subscription e-mail by sending a subscribe message to an automated mail server that manages a mailing list, or requesting to receive the subscription e-mail via a web page. The subscription e-mail may include product information or updates to a product the user has purchased, information from news groups that are of interest to the user, etc. If the user no longer desires to receive the subscription e-mail, the user must “unsubscribe” from the mailing list, which again involves sending an e-mail to the automated mail server, or requesting to stop receiving the subscription e-mail via a web page. Finally, if the user desires to again receive the subscription e-mail, the user must once again subscribe to the mailing list via the automated mail server or web page.

A variety of e-mail management systems and methods that prevent delivery of unsolicited e-mail are known. These systems and methods, however, are generally not user friendly to an unsophisticated e-mail user. Furthermore, these systems and methods are generally designed to permanently block unsolicited or unwanted e-mail, and do not readily facilitate the management of the termination and resumption of e-mail subscriptions.

### SUMMARY

A system for selectively stopping the delivery of e-mail messages sent to a user address over a communication network comprises first software executable on a first computer device. The software is stored in a computer readable medium accessible by the first computer device and comprises code operable to define an e-mail stop storage area and store in the e-mail stop storage area e-mail data of e-mail messages selected by the user. The code is further operable to automatically generate stop data based on the e-mail data stored in the e-mail stop storage area to stop the delivery to the user address e-mail messages that correspond to the stored e-mail data.

### BRIEF DESCRIPTION OF THE DRAWINGS

FIG. 1 is a block diagram of an e-mail management system;

FIG. 2 is an inbox user interface of an e-mail program that includes the e-mail management system;

FIG. 3 is a stopped mail user interface for the e-mail program including the e-mail management system;

FIG. 4 is a flow diagram illustrating the process of automatically generating e-mail stop data and corresponding e-mail filter updates;

FIG. 5 is a flow diagram illustrating the process of filtering incoming e-mail;

FIG. 6 is a flow diagram illustrating the process of automatically generating e-mail resume data and corresponding e-mail filter updates;

FIG. 7 is a block diagram of an automatic transmission of stop data or resume data to a sender;

FIG. 8 is a flow diagram illustrating the process updating a sender address list based on stop data received; and

FIG. 9 is a flow diagram illustrating the process of updating a sender address list based on resume data received.

### DETAILED DESCRIPTION

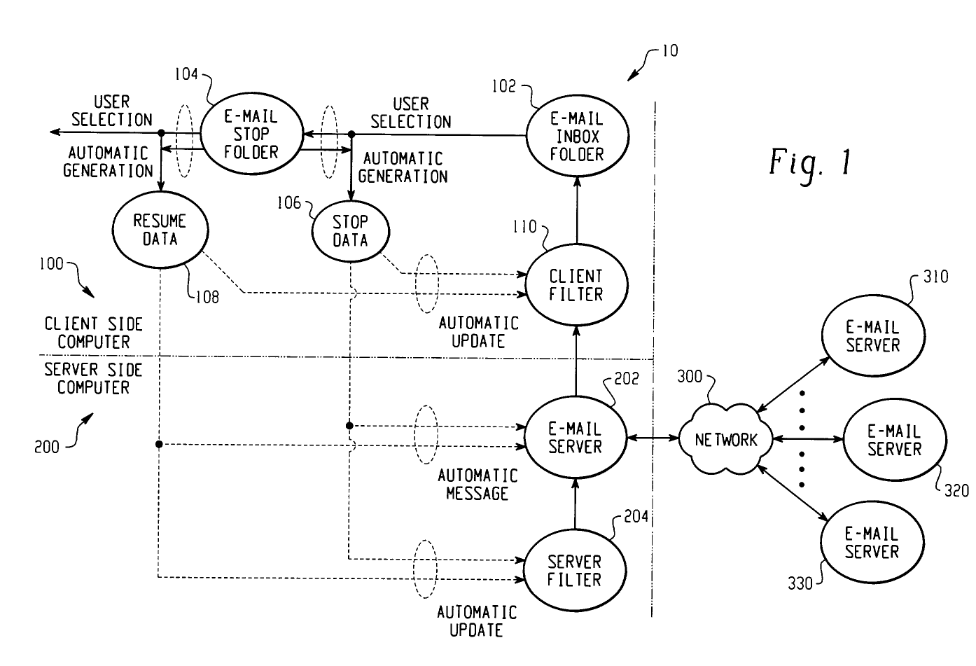

FIG. 1 is a block diagram of an e-mail management system 10. The system 10 is illustratively realized using an executable program stored on a computer readable medium accessible by a user's computer. The computer is operable to execute the program either automatically or at the direction of the user. Illustratively, the executable program can be one of a variety of e-mail client programs, such as Microsoft Outlook Express, Lotus Notes, Eudora, and the like. Additionally, the executable program may also be a web-based e-mail environment, such as Hotmail.com, Yahoo.com, Juno.com, and the like. The executable program may be a compiled program resident on the computer, or may instead be a temporarily stored set of instructions associated with a web-based application environment, such as Java and the like.

In one embodiment, the system 10 is realized on a client side computer 100. The system 10 includes an e-mail inbox folder 102 and an e-mail stop folder 104. The user is associated with one or more e-mail addresses, and the e-mail inbox folder 102 represents a storage area in which the e-mail program stores e-mail messages addressed to the user upon receiving the e-mail.

After reviewing the e-mail stored in the inbox folder 102, the user may determine that an e-mail is an unsolicited e-mail and thus may desire to prevent delivery of further e-mail from the sender of the unsolicited e-mail. To do so, the user selects the unsolicited e-mail and places it in the e-mail stop folder 104. The system 10 then automatically generates stop data 106 based on the unsolicited e-mail stored in the e-mail stop folder 104 to prevent delivery of any further e-mail sent to the user address from the sender.

The user may also determine that an e-mail is a subscription e-mail, and may further decide to temporarily stop receiving the subscription e-mail. To do so, the user selects the subscription e-mail and places it in the e-mail stop folder 104. The system 10 then automatically generates stop data 106 based on the subscription e-mail stored in the e-mail stop folder 104 to prevent delivery of any further e-mail sent to the user address from the sender. When the user decides to resume receiving the subscription e-mail, the user may select the subscription e-mail and remove it from the e-mail stop folder 104. The system 10 then automatically generates resume data 108 based on the subscription e-mail removed from the e-mail stop folder 104 to accept further e-mail messages sent to the user address from the sender.

In another embodiment, the system 10 includes a client filter 110 that receives the stop data 106 and the resume data 108 and filters incoming e-mail to prevent delivery of e-mail based on the stop data 106 and the resume data 108 received.

In a further embodiment, the system 10 allows the user to select from a set of key words or phrases to filter incoming e-mail to prevent deliver of e-mail based on the selected key words or phrases. Such key words or phrases may be based on the stop data 106 previously generated, or may be manually entered by the user, or may a predefined set of key words or phrases provided with the system 10. The predefined set of key words or phrases may include terms associated with commonly offensive materials or known scams, e.g. “XXX” or “Goodtimes Virus,” etc.

In another embodiment, the system 10 includes executable software on a server side computer 200 in communication with the client side computer 100. The client side computer 100 communicates with an e-mail server 202 to facilitate communication of e-mail messages. The e-mail server 202 includes a server filter 204, and receives e-mail from and transmits e-mail to a network 300. The network 300 includes any network that may facilitate the communication of e-mail, such as the Internet, a LAN, a wireless communication network, a satellite communication network, and the like. A plurality of network devices, illustratively e-mail servers 310, 320 and 330, from which senders send e-mail to the user and receive e-mail from the user is connected to the network 300.

The server filter 204 receives the stop data 106 and the resume data 108 from the client side computer 100 and filters incoming e-mail to prevent the delivery of e-mail based on the stop data 106 and the resume data 108 received.

In another embodiment, when the system 10 automatically generates stop data 106 to stop receiving a subscription e-mail or resume data 108 to resume receiving a subscription e-mail, the system 10 automatically transmits the stop data 106 or resume data 108 generated to the network device 310, 320 or 330 associated with the address of the sender of the subscription e-mail. Upon receiving the stop data 106 or the resume data 108, the network device 310, 320 or 330 removes the user's address from or adds the user's address to a sender's address list for the subscription e-mail.

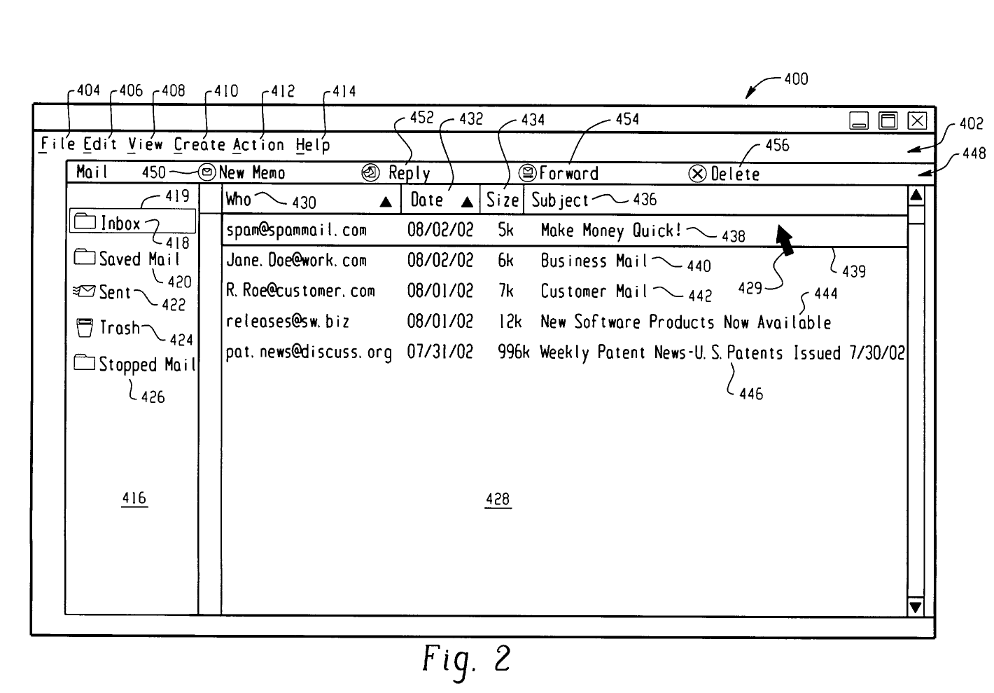

FIG. 2 is an inbox user interface 400 of an illustrative e-mail program that includes the e-mail management system 10. The inbox user interface 400 is illustrative only; other e-mail programs or devices as described above may also be used in conjunction with the e-mail management system 10.

The inbox user interface 400 includes a standard menu selection bar 402. The menu selection bar 402 illustratively includes drag and drop menus file 404, edit 406, view 408, create 410, actions 412, and help 414. Each of the drag and drop menus 404, 406, 408, 410, 412 and 414 provides standard e-mail menu functions and functions unique to the particular illustrative e-mail program.

A first frame 416 displays an inbox folder 418, a saved mail folder 420, a sent folder 422, a trash folder 424, and a stopped mail folder 426. Additional folders may be created by the user. Each folder 418, 420, 422, 424, and 426 represents a storage area in which e-mail messages are stored. Alternatively, each folder 418, 420, 422, 424, and 426 may instead represent a database index associated with each e-mail message by which the e-mail program associates e-mail messages with the folders 418, 420, 422, 424 and 426. Other storage or addressing schemes known to those of ordinary skill in the art may also be implemented using the graphical folder representation of FIG. 2.

In this particular exemplary embodiment, the inbox folder 418 represents a storage area in which the e-mail program stores e-mail addressed to the user upon the e-mail program receiving the e-mail. The selection box 419 surrounding the inbox folder 418 indicates that the inbox folder 418 is currently selected. The contents of the selected folder are displayed in the second frame 428. The saved mail folder 420 represents a storage area in which the e-mail program stores e-mail selected by the user for storage in a folder other than the inbox folder 418. The sent folder 422 represents a storage area in which the e-mail program stores a copy of all e-mail sent by the user. The trash folder 424 represents a storage area in which the e-mail program stores e-mail selected by the user for deletion. The stopped mail folder 426 represents a storage area in which the e-mail program stores unwanted or unsolicited e-mail. The user places the unwanted or unsolicited e-mail in the stopped mail folder 420 to prevent delivery of further e-mail sent to the user from the sender of the unwanted or unsolicited e-mail, or further e-mail of a similar subject type sent to the user.

The second frame 428 displays the e-mail stored in a currently selected folder. The second frame 428 illustratively includes a who field 430, a date field 432, a size field 434, and a subject field 436. An e-mail 438 is currently selected, as indicated by the selection box 439 surrounding the field displays 430, 432, 434, and 436 of the e-mail 438. A pointer 429 used in conjunction with standard click and drag techniques known in the art facilitates the selection of e-mail in the second frame 428, and the transfer of e-mail between folders 418, 420, 422, 424, and 426. The who field 430 displays the sender address of an e-mail. The date field 432 displays the date an e-mail was sent by the sender. The size field 434 displays the size in kilobytes of an e-mail. The subject field 436 displays the subject of an e-mail.

The inbox user interface 400 also includes an e-mail menu bar 448, which includes new memo button 450, reply button 452, forward button 454, and delete button 456. Pressing the new memo button 450 creates a new e-mail for the user to edit and send to an addressee. Pressing the reply button 452 creates a reply e-mail to the sender of an e-mail selected by the user. Pressing the forward button 454 forwards an e-mail selected by the user to an addressee the user has selected. Pressing the delete button 456 removes an e-mail message from the inbox 418 and places it in the trash folder 424.

As shown in FIG. 2, the user has received e-mail messages 438, 440, 442, 444 and 446, and they are stored in the user's inbox folder 418. The e-mail message 438 contains the subject “Make Money Quick!”, which is a common type of unsolicited e-mail. The e-mail message 440 and 442 are business related e-mail, the former from a co-worker and the latter from a customer. The e-mail message 444 is a subscription e-mail sent to the user upon the occurrence of a specific event, e.g., when new software products from a vendor become available. The e-mail message 446 is a subscription e-mail provided on a periodic basis, e.g., provided every week and containing a summary of newly issued United States patents.

Upon reviewing the e-mail messages 438, 440, 442, 444, 446, the user may decide to prevent delivery of further reception of e-mail from the sender e-mail message 438, and temporarily suspend delivery of subscription e-mail 444 and 446. The user can accomplish this by placing the e-mail messages 438, 444, and 446 in the stopped mail folder 426.

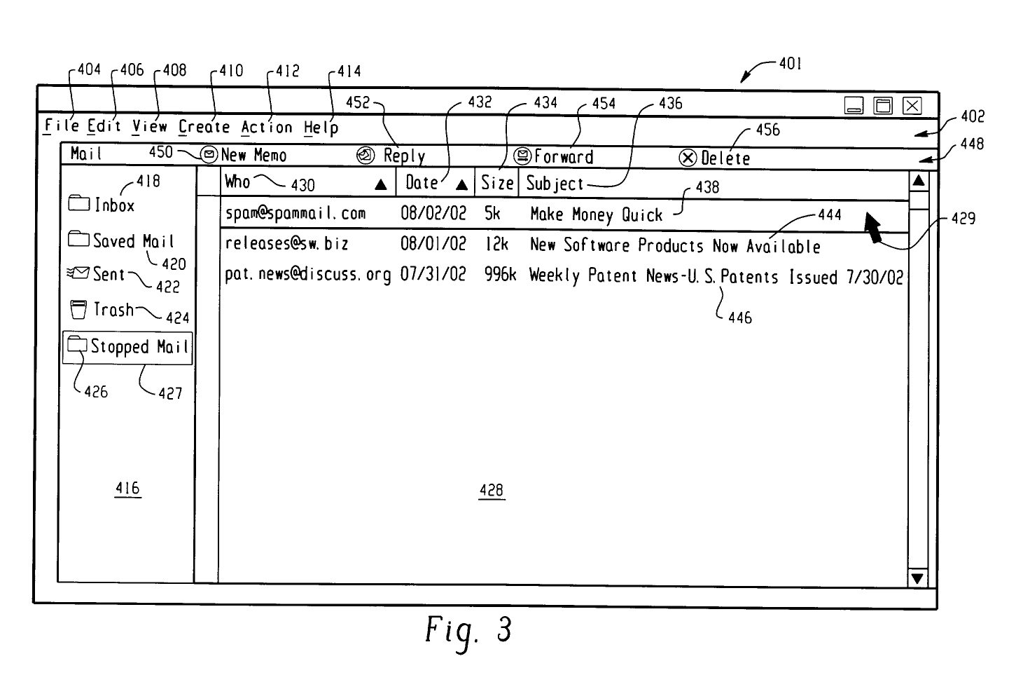

FIG. 3 shows a stopped mail user interface 401. The stopped mail user interface 401 is substantially similar to the inbox user interface 400 described in FIG. 2, except that the stopped mail user interface 401 displays e-mail messages stored in the stopped mail folder 426. Note that the shaded bar 427 surrounds the stopped mail folder 426, indicating that the contents of the stopped mail folder 426 are displayed in the second frame 428.

As shown in FIG. 3, the e-mail messages 438, 444, and 446 have been moved from the inbox folder 418 to the stopped mail folder 426. The e-mail messages 438, 444 and 446 are moved by using the pointer 429 and conventional click and drag techniques known in the art.

The system 10 automatically generates stop data 106 based on the e-mail data of each e-mail stored in the stopped mail folder 426. With respect to FIG. 3, the system 10 automatically generates stop data 106 for the e-mail messages 438, 444 and 446. At a later time, if the user desires to resume receiving e-mail from a particular sender, the user needs merely to remove the e-mail stored in the stopped mail folder 426 and the system 10 automatically generates resume data 108 based on the e-mail removed from the stopped mail folder 426. For example, if the user at a later date determines he or she desires to resume receiving e-mail from the sender address “releases@sw.biz” and “pat.news@discuss.org,” the user merely selects the e-mail messages 444 and 446 and places them in the saved mail folder 420. Alternatively, the user may place the e-mail messages 444 and 446 in another storage folder other than the saved mail folder 420.

Pressing the delete button 456 to delete a selected e-mail from the stopped mail folder 420 will move the selected e-mail to the trash folder 424 without generating resumption data. Thus, if the user decides to permanently block e-mail from a particular source, such as the source “spam@spammail.com,” as shown with respect to e-mail message 438, the user needs merely to press the delete button 456 and the e-mail message 438 is removed from the stopped mail folder 426 without the system generating resume data 108. Accordingly, the user need not accumulate hundreds, or even thousands, of stored e-mail in the stopped mail folder 426 to permanently block delivery.

The system 10 may prevent the delivery of e-mail and resume the delivery of e-mail according to several different methods. In one embodiment, the system 10 includes a client filter 110 located on the client side computer 100. The client filter 110 receives the stop data 106 and the resume data 108 and filters incoming e-mail to prevent delivery of e-mail in response to the stop data 106 and the resume data 108 received.

The stop data 106 and the resume data 108 may comprise various e-mail data, such as the sender address, the e-mail subject, or even the text of the e-mail message body, and corresponding instructions to add the stop data 106 to the client filter 110, and remove the resume data 108 from the client filter. Furthermore, if the client filter 110 also filters according to selected key words or phrases, the selected key words or phrases may also be included.

Based on the stop data 106 and the resume data 108 received, the client filter 110 may filter e-mail according to the sender's address, the sender's domain, the sender's IP address, the subject line of the e-mail, or by other e-mail filtering techniques known in the art. For example, if the client filter 110 filters e-mail according to the sender's address, e-mail from “spam@spammail.com,” “releases@sw.biz,” and “pat.news@discuss.org” will be blocked; and e-mail messages from other addresses will be passed to the user's inbox folder 418. Similarly, if the client filter 110 filters e-mail according to a domain name, e-mail from the domains spammail.com, sw.biz, and discuss.org will be blocked. The user may configure the client filter 110 to filter according to these e-mail filtering techniques.

In another embodiment, the client filter 110 filters e-mail according to the subject field 436 of the e-mail messages stored in the stopped mail folder 426. This filtering method prevents the reception of the same or similar unsolicited or unwanted e-mail sent from different sender addresses. The client filter 110 may filter the incoming e-mail by matching the subject field 436 of an incoming e-mail message to a subject field 436 of one of the e-mail messages stored in the stopped mail folder 426, or by matching individual words in the subject field to words contained in the subject field 436 of one of the e-mail messages stored in the stopped mail folder 426.

In another embodiment, the system 10 includes executable software on the server side computer 200 in communication with the client side computer 100. The e-mail server 202 includes a server filter 204, and receives e-mail from and transmits e-mail to a network 300. The server filter 204 receives the stop data 106 and the resume data 108 from the client side computer 100 and filters incoming e-mail to prevent delivery of e-mail to the user based on the stop data 106 and the resume data 108 received from the client side computer 100. The server filter 204 filters e-mail in the same manner as described with respect to the client filter 110 described above. By filtering e-mail with the server filter 204 on the server side computer 200, e-mail that the user does not desire to receive is not stored on the e-mail server 202 or transferred to the client side computer 100 when the client side computer 100 connects to the server side computer 200. Instead, the e-mail is automatically rejected by the e-mail server 202 through the server filter 204. Accordingly, unwanted e-mail does not take up storage space on the e-mail server 202.

In another embodiment, the system 10 automatically transmits the stop data 106 or the resume data 108 generated to the network device 310, 320 or 330 associated with the sender's address. Upon receiving the stop data 106 or the resume data 108, the network device 310, 320 or 330 removes the user's address from or adds the user's address to the sender's address list for a subscription e-mail. Thus, when a user decides to temporarily unsubscribe from a subscription e-mail, the sender of the subscription e-mail is automatically notified and the sender's address list is modified accordingly.

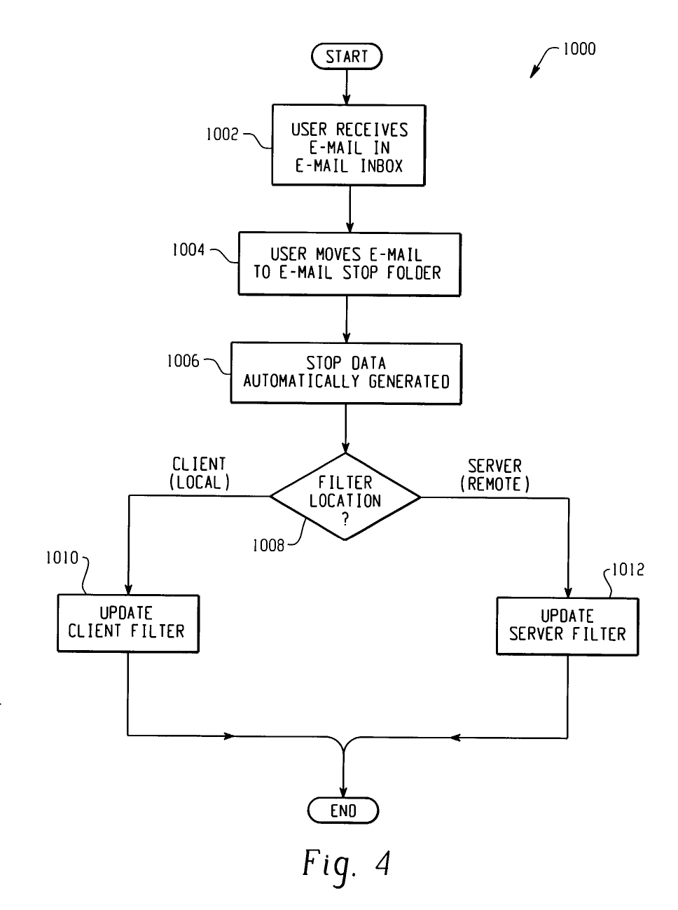

FIGS. 4-9 provide flow diagrams illustrating exemplary processes implemented in the e-mail management system 10 of FIG. 1. FIG. 4 provides a flow diagram 1000 illustrating the process of automatically generating e-mail stop data 106 and e-mail filter updates. In step 1002, the user receives e-mail in the e-mail inbox folder 102. After reviewing the e-mail stored in the inbox folder 102, the user may decide to move a particular e-mail to the e-mail stop folder 104, as shown in step 1004. When an e-mail is placed in the e-mail stop folder 104, stop data 106 is automatically generated, as shown in step 1006. In step 1008, the system 10 determines whether a client filter 110 or a server filter 204 is being used. If a client filter 110 is being used, the client filter 110 is updated on the client side computer 100, as shown in step 1010. On the other hand, if a server filter 204 is being used, the stop data 106 is transmitted to the server side computer 200, and the server filter 204 is automatically updated as shown in step 1012. Thus, by simply taking an unsolicited or unwanted e-mail from an e-mail inbox folder 102 and placing it in an e-mail stop folder 104, the user causes the system 10 to automatically generate stop data 106 that automatically updates a client filter 110 or a server filter 204, thus preventing delivery of future e-mail from the sender of the selected e-mail, or future e-mail of similar type.

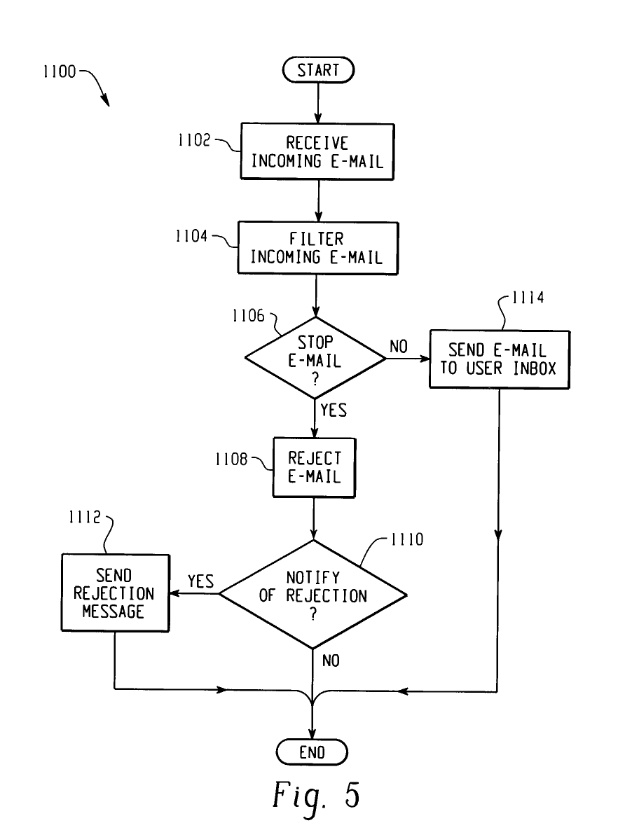

FIG. 5 provides a flow diagram 1100 illustrating the process of filtering incoming e-mail. The flow diagram 1100 illustrates the filtering process of either the client filter 110, or the server filter 204, depending upon which filter is used. In step 1102, the system 10 receives an incoming e-mail. In step 1104, the system 10 applies either the server filter 204 or the client filter 110 to filter the incoming e-mail as previously described. In step 1106, the system 10 determines whether the e-mail has been stopped by the client filter 110 or the server filter 204. If the e-mail has been stopped, system 10 rejects the e-mail in step 1108. In step 1110, the system 10 determines whether to send the sender a notification of the e-mail rejection.

The determination of whether to send a notification of rejection to the sender of the rejected e-mail may be determined by the user on the client side computer 100, or may be determined by a system administrator on the server side computer 200. If a notification of rejection is to be sent, the system 10 sends a rejection message in step 1112. In one embodiment, the rejection message is an automated message demanding that the sender not send any further e-mail to the user's address. In another embodiment, the rejection message comprises data indicating that the user's e-mail address is an invalid e-mail address. Alternatively, if no rejection notification is to be sent, no further action is taken, and the sender is not notified of whether the user has received the rejected e-mail.

Returning to step 1106, if the client filter 110 or the server filter 204 determines that the incoming e-mail should not be stopped, the e-mail passes through the filter and is sent to the user inbox as shown in step 1114.

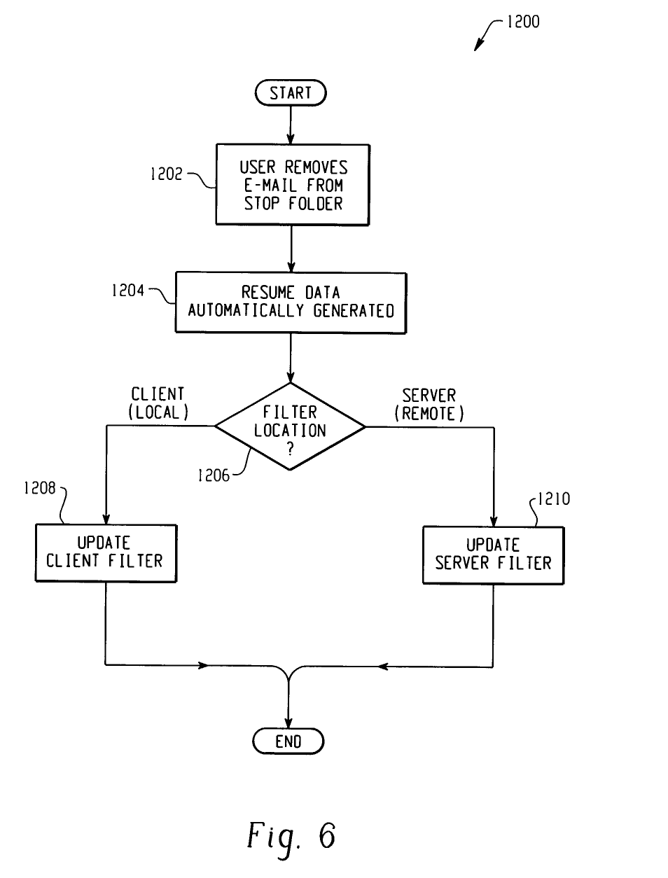

FIG. 6 provides a flow diagram 1200 illustrating the process of automatically generating e-mail resume data 108 and e-mail filter updates. When the user decides to resume receiving a subscription e-mail, the user removes the e-mail from the stop folder 104, as shown in step 1202. Once the e-mail is removed from the stop folder 104, resume data 108 is automatically generated based upon the e-mail removed from the stop folder 104, as shown in step 1204. In step 1206, the system 10 determines whether a client filter 110 or a server filter 204 is being utilized. If a client filter 110 is being utilized, the client filter 110 is automatically updated in step 1208. On the other hand, if the server filter 204 is being utilized, the resume data is sent to the server side computer 200 and the server filter 204 is automatically updated as shown in step 1210. Thus, by simply removing an e-mail from the e-mail stop folder 104, the user causes the system 10 to automatically generate resume data 108 so that the user may resume receiving a subscription e-mail.

In another embodiment, resume data 108 is only generated in step 1204 if e-mail is removed from the e-mail stop folder 104 by any method other than a deletion operation. By not generating resume data 108 when a deletion operation is used on an e-mail message stored in the e-mail stop folder 104, the system 10 does not require storage of hundreds, or perhaps even thousands, of e-mail messages that the user no longer desires to receive.

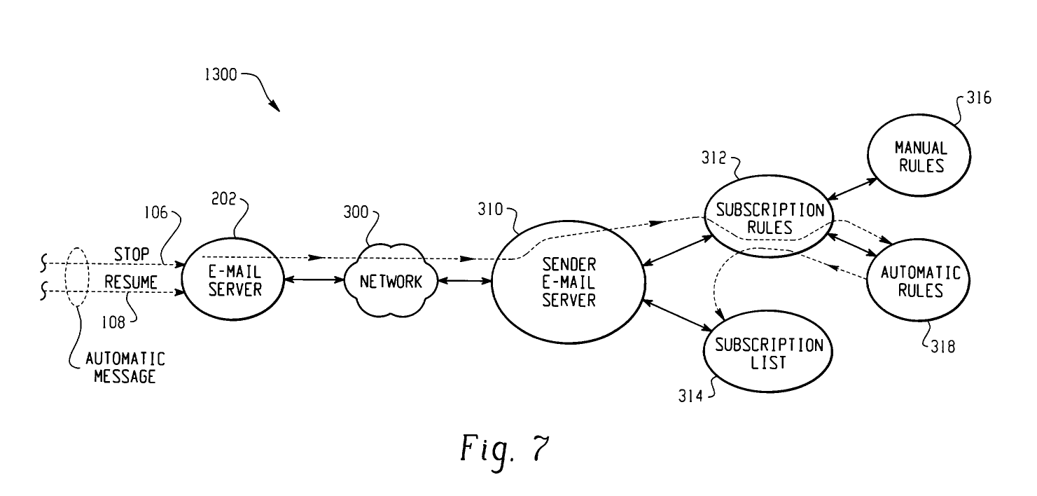

FIG. 7 is a block diagram 1300 of an automatic transmission of stop data 106 and/or resume data 108 to a sender. As previously described, a user may subscribe to an e-mail and receive a subscription e-mail regarding a particular subject of interest to the user. Usually the subscription e-mail has a particular method of unsubscribing or suspending a subscription. Methods may range from simply sending an e-mail to the sender with the word “unsubscribe” in the e-mail heading subject or the e-mail body, or may involve going to a particular web page and entering data to unsubscribe from the e-mail. Either method requires the user to execute a number of steps, and often the user may not have time to properly execute the steps or may execute the steps erroneously. As a result, it may take several attempts for a user to unsubscribe from a subscription e-mail. Furthermore, in cases with unsophisticated users, the users may not be aware of the steps or processes required to stop unwanted subscription e-mail.

In another embodiment, the system 10 includes software located on a sender's e-mail server 310 operable to receive the stop data 106 and the resume data 108 and manage the sender's address list automatically. As shown in FIG. 7, stop data 106 and resume data 108 are automatically transferred to the sender's e-mail server 310 via the e-mail server 202 and the network 300. The sender's e-mail server 310 accesses a set of subscription rules 312 and a subscription list 314 to manage a subscription e-mail. The subscription rules 312 illustratively comprise a set of manual rules 316 and a set of automatic rules 318.

The manual rules 316 govern manual requests from a user to subscribe and unsubscribe from a subscription e-mail. For example, the manual rules 316 may require that a user log onto a web page and provide a password and other data to subscribe to a particular subscription e-mail. Likewise, the manual rules 316 may require that the user log onto a particular web page and provide a password and other data to unsubscribe from a particular subscription e-mail.

The automatic rules 318 govern the managing of a subscription e-mail through the reception of the stop data 106 and the resume data 108. Thus, regardless of the requirements of the manual rules 316, a user may selectively unsubscribe and subscribe to a particular subscription e-mail by placing and removing that subscription e-mail in the e-mail stop folder 104.

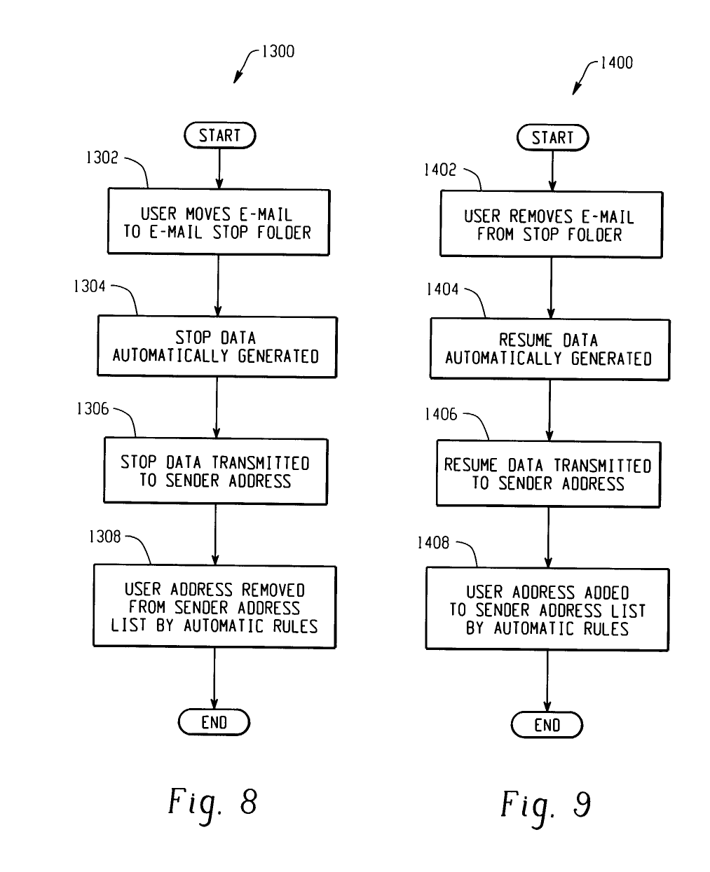

FIG. 8 provides a flow diagram 1300 illustrating the process of updating a sender address list based on the stop data 106 received. In step 1302, the user moves an e-mail to the e-mail stop folder 104. In step 1304, stop data 106 is automatically generated based on the e-mail moved to the e-mail stop folder 104. The stop data may include the user's e-mail address or an identifier that the sender associates with the user (e.g., a customer number, a password, etc.). In step 1306, the stop data 106 are automatically transmitted to the mail server 310 associated with the sender address. In step 1308, the user address is removed from the sender address list according to the automatic rules 318.

FIG. 9 is a flow diagram 1400 describing the process of updating a sender address list based on the resume data 108 received. In step 1402, the user removes an e-mail from the e-mail stop folder 104. In step 1404, the resume data 108 is automatically generated based on the e-mail removed from the e-mail stop folder 104. In step 1406, the resume data 108 are automatically transmitted to the mail server 310 associated with the sender address. In step 1408, the user address is added to the sender address list according to the automatic rules 318.

While the exemplary embodiments describe the system 10 as being embedded within an e-mail program, other variations exist. For example, system 10 may be implemented as a utility program separate from the e-mail program.

The embodiments described herein are examples of structures, systems or methods having elements corresponding to the elements of the invention recited in the claims. This written description may enable those of ordinary skill in the art to make and use embodiments having alternative elements that likewise correspond to the elements of the invention received in the claims. The intended scope of the invention thus includes other structures, systems or methods that do not differ from the literal language of the claims, and further includes other structures, systems or methods with insubstantial differences from the literal language of the claims.

What is claimed is:

1. A system for selectively stopping the delivery of e-mail messages sent to a user address over a communication network, the system comprising first software executable on a first computer device and stored in a computer readable medium accessible by the first computer device, the first software comprising code operable to:
define an e-mail stop storage area;
store in the e-mail stop storage area e-mail data of e-mail messages selected by the user for rejection; and
automatically generate stop data based on the e-mail data stored in the e-mail stop storage area to stop the delivery to the user address e-mail messages that correspond to the stored e-mail data.

2. The system of claim 1, wherein the first software further comprises code operable to:
remove from the e-mail stop storage area e-mail data of e-mail messages selected by the user for resumption; and
automatically generate resume data based on the e-mail data removed from the e-mail stop storage area to resume delivery to the user address e-mail messages that correspond to the removed e-mail data.

3. The system of claim 2, wherein the first software further comprises code operable to generate an e-mail filter based on the stop data and the resume data, the e-mail filter operable to receive e-mail messages sent to the user address and reject e-mail messages corresponding to the stop data and pass e-mail messages corresponding to the resume data.

4. The system of claim 3, wherein the first software further comprises code operable to send rejection data to the sender address of an e-mail message when the e-mail filter rejects the e-mail message.

5. The system of claim 4, wherein the rejection data comprises data indicating that the user address is an invalid address.

6. The system of claim 3, wherein the stop data and the resume data comprise the user address and the sender address.

7. The system of claim 2, wherein the e-mail stop storage area comprises an e-mail folder accessible by an e-mail program.

8. The system of claim 7, wherein the e-mail data of an e-mail message selected by the user comprises a sender address.

9. The system of claim 8, wherein the e-mail data of an e-mail message selected by the user further comprises a subject heading.

10. The system of claim 2, wherein the first computer device is a personal computer.

11. The system of claim 2, wherein the first computer device is a wireless communication device.

12. The system of claim 1, wherein:
the e-mail data of e-mail selected by the user comprises a sender address; and
the first software further comprises code operable to transmit the stop data over the communication network to a second computer device corresponding to the sender address.

13. The system of claim 12, further comprising second software executable on the second computer device and stored in a computer readable medium accessible by the second computer device, the second computer device operable to send e-mail messages over the communication network, the second software comprising code operable to:
store a distribution list of e-mail addresses corresponding to e-mail recipients;
receive the stop data transmitted by the first software; and
remove the user address from the distribution list of e-mail addresses in response to receiving the stop data.

14. The system of claim 13, wherein:
the first software further comprises code operable to:
remove from the e-mail stop storage area e-mail data of e-mail messages selected by the user for resumption; and
automatically generate resume data based on the e-mail data removed from the e-mail stop storage area to resume delivery to the user address e-mail messages that correspond to the e-mail data removed; and
transmit the resume data to the sender address over the communication network; and
the second software further comprises code operable to:
receive the resume data transmitted by the first software; and
add the user address to the distribution list of e-mail addresses in response to receiving the resume data.

15. The system of claim 2, further comprising second software executable on a second computer device and stored in a computer readable medium accessible by the second computer device, the second computer device in communication with the first computer device and operable to send and receive e-mail messages over the communication network, the second software comprising code operable to generate an e-mail filter based on the stop data and the resume data, the e-mail filter operable to receive e-mail messages sent to the user address and reject e-mail messages corresponding to the stop data and pass e-mail messages corresponding to the resume data.

16. A method of selectively stopping the delivery of e-mail messages sent to a user address over a communication network, the method comprising the steps of:
defining an e-mail stop storage area;
storing in the e-mail stop storage area e-mail data of e-mail messages selected by the user for rejection; and
automatically generating stop data based on the e-mail data stored in the e-mail stop storage area to stop the delivery to the user address e-mail messages that correspond to the stored e-mail data.

17. The method of claim 16 further comprising the steps of:
removing from the e-mail stop storage area e-mail data of e-mail messages selected by the user for resumption; and
automatically generating resume data based on the e-mail data removed from the e-mail stop storage area to resume delivery to the user address e-mail messages that correspond to the removed e-mail data.

18. The method of claim 17, further comprising the steps of:
rejecting e-mail messages corresponding to the stop data; and
passing e-mail messages corresponding to the resume data.

19. The method of claim 18, further comprising the step of sending a rejection message to a sender address of an e-mail message after rejecting the e-mail message.

20. The method of claim 19, wherein the stop data and the resume data comprise the user address and the sender address.

21. The method of claim 17, wherein the e-mail stop storage area comprises an e-mail folder accessible by an e-mail program.

22. The method of claim 21, wherein the e-mail data of e-mail selected by the user comprises a sender address.

23. The method of claim 21, wherein the e-mail data of e-mail selected by the user further comprises a subject heading.

24. A system for selectively stopping the delivery of e-mail messages sent to a user address from a sender address over a communication network, the system comprising first software executable on a first computer device and stored in a computer readable medium accessible by the first computer device, the first software comprising code operable to:
define an e-mail stop key;
associate with the e-mail stop key e-mail messages selected by the user for rejection; and
automatically generating stop data based on the e-mail messages associated with the e-mail stop key to stop the delivery to the user address e-mail messages sent to the user address that correspond to the e-mail stop key.

25. The system of claim 24, wherein the first software further comprises code operable to:
disassociate from the e-mail stop key e-mail messages selected by the user for resumption; and
automatically generate resume data based on the e-mail messages disassociated from the e-mail stop key to resume the delivery to the user address e-mail messages that correspond to the e-mail messages disassociated with the e-mail stop key.

26. The system of claim 25, wherein the first software further comprises code operable to generate an e-mail filter based on the stop data and the resume data, the e-mail filter operable to receive e-mail messages sent to the user address and reject e-mail messages corresponding to the stop data and pass e-mail messages corresponding to the resume data.

27. The system of claim 26, wherein the e-mail stop key is a database index.

28. The system of claim 26, wherein the stop data comprises a sender address.

29. The system of claim 28, wherein the stop data further comprises a subject heading.

30. The system of claim 25, wherein the first software further comprises code operable to transmit the stop data and the resume data over the communication network to a second computer device corresponding to the sender address.

31. The system of claim 30, further comprising second software executable on the second computer device and stored in a computer readable medium accessible by the second computer device, the second computer device operable to send e-mail messages over the communication network, the second software comprising code operable to:
store a distribution list of e-mail addresses corresponding to e-mail recipients;
receive the stop data transmitted by the first software;
remove the user address from the distribution list of e-mail addresses in response to receiving the stop data;
receive the resume data transmitted by the first software device; and
add the user address to the distribution list of e-mail addresses in response to receiving the resume data.

32. The system of claim 25, further comprising second software executable on a second computer device and stored in a computer readable medium accessible by the second computer device, the second computer device in communication with the first computer device and operable to send and receive e-mail messages over the communication network, the second software comprising code operable to generate an e-mail filter based on the stop data and the resume data, the e-mail filter operable to receive e-mail messages sent to the user address and reject e-mail messages corresponding to the stop data and pass e-mail messages corresponding to the resume data.

33. The system of claim 26, further comprising a list of key words selectable by the user, and wherein the e-mail filter is operable to receive e-mail messages sent to the user address and reject e-mail messages containing key words selected by the user and pass e-mail messages that do not contain key words selected by the user.
